(19) United States
(12) Patent Application Publication
(10) Pub. No.: US 2004/0245174 A1
(43) Pub. Date: Dec. 9, 2004

(54) Water purification cartridge, water purifier and method for cleaning water purifier

(76) Inventors: Hitoshi Takayama, Tajimi-shi (JP); Tatsuhiro Katou, Owariasahi-shi (JP); Masahiko Taneike, Tokyo (JP); Masaru Uehara, Kasukabe-shi (JP); Manabu Yanou, Toda-shi (JP)

Correspondence Address: FITCH, EVEN, TABIN & FLANNERY, P. O. BOX 65973, WASHINGTON, DC, 20035, US

(21) Appl. No.: 10/488,607

(22) PCT Filed: Sep. 3, 2002
(86) PCT No.: PCT/JP02/08929

(30) Foreign Application Priority Data
Sep. 5, 2001 (JP) 2001-268866
Sep. 6, 2001 (JP) 2001-270956
Jun. 18, 2002 (JP) 2002-177067

(51) Int. Cl. B01D 65/02; B01D 63/02

(52) U.S. Cl. 210/636; 210/321.79; 210/321.8; 210/500.23

(57) ABSTRACT

An object of the present invention is to provide a water purification cartridge in which the decreased function of the hollow fiber membranes is restored by cleaning and of which the operating cost of a purification treatment of raw water decreases. The present invention provides a water purification cartridge comprising a hollow fiber membrane element comprising a plurality of hollow fiber membranes bent in a U-shape and a potting material for binding both ends of the hollow fiber membranes so as to maintain the open states of the hollow fiber membranes and a cylindrical hollow fiber membrane case for covering the hollow fiber membranes, wherein the hollow fiber membrane element is detachably installed in the hollow fiber membrane case so that a fluid-tight state is maintained between the primary side and the secondary side of the hollow fiber membranes.

### TECHNICAL FIELD

The present invention relates to a water purification cartridge which is detachably installed in a water purifier and which purifies tap water and the like, a water purifier, and a method for cleaning a water purifier.

### BACKGROUND ART

Recently, in consideration of pollution of water resources and with demands for high-quality water, water purifiers are used for purification of tap water. As the purifiers, purifiers, which remove the smell of chlorine and mold, trihalomethane by adsorbents such as an activated carbon, and which remove bacteria and a turbid component by a porous hollow fiber membrane, have been used.

Such purifiers include, for example, a water purifier 1 which is directly connected with a faucet and which is shown in FIG. 18. The water purifier 1 is provided with a faucet 2 using an adaptor 3 and a fixing ring 4. By operation of a switch lever 5, a switch mechanism portion inside the water purifier 1 moves to flow raw water or purified water. A water purification cartridge is installed in a cartridge cover 7 of the water purifier 1. In the water purifier 1, when the switch lever 5 is changed to a side which flows purified water and raw water is allowed to flow into the water purifier 1 from the faucet 2, raw water is introduced to the inside the water purification cartridge by the switch mechanism portion and passes through the filter, and raw water is changed into purified water, and then the purified water is allowed to flow down from a purified water outlet 9.

FIG. 19 is a cross-sectional view showing one example of a water purification cartridge used for the water purifier 1. A water purification cartridge 6 comprises a cylindrical case 13 which comprises a sintered filter 11 at the back end and a cover comprising a purified water outlet 12 at the front end; a partition wall 14 which divides the inside the case 13 into a side of the sintered filter 11 and another side of the purified water outlet 12; an adsorbent 15 which is filled in the side of the sintered filter 11 of the case 13; and a plurality of hollow fiber membranes 16 which are fixed in the side of the purified water outlet 12 by a potting material 17. The hollow fiber membranes 16 are fixed in the case 13 by a potting material 17 so as to maintain the open states of a plurality of the hollow fiber membranes 16 bent in a U-shape. In the water purification cartridge 6, raw water passes through the sintered filter 11 and is introduced into the water purification cartridge 6. The raw water introduced into the water purification cartridge 6 passes the adsorbent 15, the partition wall 14, and the hollow fiber membranes 16 in this turn, and the raw water is purified while passing therethrough. Purified water which is obtained by purifying raw water is allowed to flow out from the purified water outlet 12 to the outside of the water purification cartridge 6.

When a water purification treatment will be conducted using the water purifier 1 comprising the water purification cartridge 6, depending on the degree of pollution and the treatment amount of raw water, bacteria, turbid components, etc. become attached and deposited on a surface (a primary side) of the hollow fiber membranes 16, and this causes a blockage of the hollow fiber membranes 16. When the hollow fiber membranes 16 become to be in such a condition, the function of the hollow fiber membranes 16 cannot be recovered without cleaning of the surface thereof.

However, since the hollow fiber membranes 16 are fixed in the case 13 by the potting material 17 and the case 13 does not disassemble, it is impossible to clean the surface of the hollow fiber membranes 16. Therefore, when a blockage occurs in the hollow fiber membranes 16 and the function of the hollow fiber membranes 16 remarkably decreases, even when the adsorbent 15 has sufficient absorbing ability, there is no choice but to change the entirety of the water purification cartridge 6. This is one of the factors which remarkably increases operating cost of water purification using the water purifier 1.

In order to prevent the blockage of the hollow fiber membranes, Japanese Unexamined Patent Application, First Publication No. Hei 8-89948 discloses a method for removing blocking material on the surface of the hollow fiber membranes by backflowing from the secondary side of the hollow fiber membranes. However, in this method, dirty raw water is sent from the secondary side of the hollow fiber membranes. Therefore, instead of cleaning, there is a possibility that the inside the hollow fiber membranes will be contaminated.

Japanese Unexamined Patent Application, First Publication No. Hei 8-84989 discloses a method for back washing the hollow fiber membranes by arranging a plurality of the hollow fiber membrane modules and back washing the hollow fiber membrane module using the filtered water of another hollow fiber membrane module. This method requires a plurality of the hollow fiber membrane modules and this causes the filtering portion to be large and an increase of component parts.

In consideration of the above-described problems, it is an object of the present invention to provide a water purification cartridge in which the function of the hollow fiber membranes is restored by cleaning, and operating cost of a purification treatment of raw water is decreased, a water purifier, and a method for cleaning a water purifier.

### DISCLOSURE OF INVENTION

In order to achieve the object, the present invention provides a water purification cartridge which comprises a hollow fiber membrane element comprising a plurality of hollow fiber membranes bent in a U-shape and a potting material for binding both ends of the hollow fiber membranes so as to maintain the open states of the hollow fiber membranes; and a cylindrical hollow fiber membrane case for covering the hollow fiber membranes, wherein the hollow fiber membrane element is detachably installed in the hollow fiber membrane case so that a fluid-tight state is maintained between the primary side and the secondary side of the hollow fiber membranes.

According to the water purification cartridge, it is possible to clean and restore hollow fiber membranes of which the function has decreased, and to reduce the operating cost of the purification treatment of raw water.

In the water purification cartridge, it is preferable for a connection device to be provided to the hollow fiber membrane case, and for one connection member which is one of a screw type connection member, a bayonet type connection member, and a flange type connection member, which engages the connection device to be provided in the side surface of the potting material.

In the water purification cartridge, it is preferable for an adsorption filter comprising an adsorbent case and an adsorbent installed in the adsorbent case to be connected detachably at one end of the hollow fiber membrane case, and for a detachable cover to be provided to the adsorbent case such that the adsorbent installed in the adsorbent case is freely changed. According to the water purification cartridge, a purification treatment of raw water by an adsorbent can be simultaneously conducted. In addition, if necessary, the adsorption filter can be detached. Furthermore, when a cover detachable from the adsorbent case is provided, it is possible to freely change the adsorbent installed in the adsorbent case.

In the water purification cartridge, it is preferable for the adsorbent to be filled in a package through which water passes and to be installed in the adsorbent case. According to the water purification cartridge, the adsorbent can be changed easily.

In addition, in order to achieve the object, the present invention provides a water purifier comprising the water purification cartridge.

According to the water purifier, the operating cost of water purification treatment can be reduced.

In addition, in order to achieve the object, the present invention provides another water purifier comprising a hollow fiber membrane module in which the ends of the hollow fiber membranes are fixed to one end of a cylindrical vessel while the ends of the hollow fiber membranes are maintained in open states, wherein the hollow fiber membrane module has a hollow fiber membrane filling percentage in a range from 20 to 60%, and wherein the cylindrical vessel comprises a cleaning solvent inlet and a cleaning solvent outlet for cleaning the exterior surface of the hollow fiber membranes.

In the water purifier, it is preferable for the cleaning solvent inlet to be also a raw water inlet. According to the water purifier, the structure can be simplified.

In the water purifier, it is preferable for the cleaning solvent outlet to be provided in the side surface of the cylindrical vessel at a location near the portion at which hollow fiber membranes are fixed. According to the water purifier, the cleaning solvent spreads through the entirety of the hollow fiber membranes. In addition, since a cleaning solvent flow direction changes at the base portion of the hollow fiber membranes where a blockage is likely to most happen, the base portion is cleaned effectively and the cleaning effect of the cleaning solvent is increased.

In the water purifier, it is preferable for an adsorbent to be provided at the upstream with respect to the hollow fiber membrane module. According to the water purifier, various water purifications can be achieved.

In the water purifier, it is preferable to comprise a cleaning solvent flow device for making a cleaning solvent flow on at least a part of the exterior surface of the hollow fiber membranes in a circumferential direction with respect to the axis of the cylindrical vessel.

In addition, it is preferable for the cleaning solvent flow device to be a plate member comprising at least one cleaning solvent passage which is diagonally disposed across the plate member. According to the water purifier, flow is easy in the circumferential direction.

Furthermore, it is also preferable for the plate member to be provided at at least one position of the upstream and the circumference of the hollow fiber membranes. According to the water purifier, a stream in the circumferential direction reliably impacts the hollow fiber membranes.

In the water purifier, it is preferable for a pre-filter having a mesh larger than the mesh of the hollow fiber membranes, to be provided at the upstream of the hollow fiber membrane module. According to the water purifier, the life service of the hollow fiber membranes increases.

In addition, it is also preferable for the pre-filter to be installed detachably.

In the water purifier, it is preferable to arrange a plurality of the hollow fiber membrane modules in a line, and while one of the hollow fiber membrane module is cleaned, to make the other hollow fiber membrane modules filter. According to the water purifier, not only can filtration be conducted while cleaning, but also the life service of the water purifier can be increased compared with a water purifier comprising one hollow fiber module.

In the water purifier, it is preferable that is comprises at least one measuring device for measuring total filtration time, total filtered amount, filtration flow rate, and filtration pressure. According to the water purifier, a filtration is conducted while cleaning, and a cleaning is conducted based on a recovery of filtration ability of the water purifier.

In addition, in order to achieve the object, the present invention provides another water purifier comprising a cleaning solvent flow device for making a cleaning solvent flow on at least a part of the exterior surface of hollow fiber membranes of a hollow fiber membrane module installed in a cylindrical vessel in a circumferential direction with respect to the axis of the cylindrical vessel.

In addition, in order to achieve the object, the present invention provides a method for cleaning a water purifier which comprises a hollow fiber membrane module in which the ends of hollow fiber membranes are fixed to one end of a cylindrical vessel while the ends of the hollow fiber membranes are maintained in open states, the hollow fiber membrane module has a hollow fiber membrane filling percentage in a range from 20 to 60%, and the cylindrical vessel comprises a cleaning solvent inlet and a cleaning solvent outlet for cleaning the exterior surface of the hollow fiber membranes, the method comprising the steps of: supplying raw water from the cleaning solvent inlet, and after the raw water passes through the hollow fiber membranes, discharging the raw water from the cleaning solvent outlet.

In the method for cleaning, it is preferable for the cleaning solvent to be allowed to flow on the exterior surface of at least a part of the hollow fiber membranes in the circumferential direction with respect to the axis of the cylindrical vessel.

In particular, it is preferable to flow the cleaning solvent in the circumferential direction of the cylinder vessel by passing through cleaning solvent passages which are diagonally disposed across the plate member. According to the method for cleaning, a flow or a stream of the cleaning solvent in the circumferential direction can be easily formed. In the method for cleaning, it is more preferable for the plate member to be provided at at least one position of the upstream and the circumference of the hollow fiber membranes. According to the method for cleaning, a water stream in the circumferential direction reliably impacts the hollow fiber membranes.

In addition, in order to achieve the object, the present invention provides another method for cleaning a water purifier which comprises a hollow fiber membrane module in which the ends of hollow fiber membranes are fixed to one end of a cylindrical vessel while the ends of the hollow fiber membranes are maintained in open states, the hollow fiber membrane module has a hollow fiber membrane filling percentage in a range from 20 to 60%, and the cylindrical vessel comprises a cleaning solvent inlet and a cleaning solvent outlet for cleaning the exterior surface of the hollow fiber membranes, the method comprising the steps of: supplying a chemical from the cleaning solvent inlet; maintaining the conditions for a fixed time; and discharging the chemical from the cleaning solvent outlet.

It is preferable for the chemical to be an aqueous solution containing one of hydrochloric acid, citric acid, acetic acid, household detergents, and hypochlorites. The aqueous solutions both effectively clean the hollow fiber membrane module and are easily obtained.

In the method for cleaning, it is preferable that after discharging the chemical from the cleaning solvent outlet, raw water be further supplied from the cleaning solvent inlet, the raw water be allowed to flow on the surface of the hollow fiber membranes, and the raw water be discharged from the cleaning solvent outlet.

In the method for cleaning, it is preferable for a pre-filter having a mesh larger than the mesh of the hollow fiber membranes be provided at the upstream of the hollow fiber membrane module.

It is preferable for the pre-filter to be installed detachably, be detached, and be cleaned.

In the method for cleaning, it is preferable to measure at least one of total filtration time, total filtered amount, filtration flow rate, and filtration pressure and to clean automatically when at least one reaches a pre-determined fixed value.

In addition, in the method for cleaning, it is also preferable that the cleaning solvent be supplied from the cleaning solvent inlet, the cleaning solvent be allowed to flow on the surface of the hollow fiber membranes, and the cleaning solvent be discharged from the cleaning solvent outlet, and thereby cleaning of the hollow fiber membranes be conducted, while filtration be also conducted, and that total filtered amount or filtration flow rate be measured from the beginning of the cleaning, the cleaning be finished when the total filtered amount or the filtration flow rate reaches a predetermined fixed value.

### BRIEF DESCRIPTION OF THE DRAWINGS

FIG. 1 is a cross-sectional view showing one of the water purification cartridges of the present invention.

FIG. 2 is a cross-sectional view showing another hollow fiber membrane in the water purification cartridge of the present invention.

FIG. 3 shows the separated hollow fiber membrane element and hollow fiber membrane case which comprising the hollow fiber membrane shown in FIG. 2.

FIG. 4 is a cross-sectional view showing one of the water purifiers of the present invention.

FIG. 5 is a perspective view showing one of plate members comprising cleaning solvent passages used in the present invention.

FIG. 6 is a perspective view showing another plate member comprising cleaning solvent passages used in the present invention.

FIG. 7 is a perspective view showing another plate member comprising cleaning solvent passages used in the present invention.

FIG. 8 is a perspective view showing another plate member comprising cleaning solvent passages used in the present invention.

FIG. 9 is a perspective view showing a cleaning solvent passage in the water purifier of the present invention.

FIG. 10 is a perspective view showing another cleaning solvent passage in the water purifier of the present invention.

FIG. 11 is a perspective view showing another plate member comprising cleaning solvent passages used in the present invention.

FIG. 12 is a cross-sectional view showing another water purifier of the present invention.

FIG. 13 is a perspective view showing the hollow fiber membrane case shown in FIG. 12.

FIG. 14 is a center axis directional cross-sectional view showing the hollow fiber membrane case shown in FIG. 12.

FIG. 15 is a vertical cross-sectional view showing the hollow fiber membrane case shown in FIG. 12.

FIG. 16 is a cross-sectional view showing another water purifier of the present invention.

FIG. 17 is a cross-sectional view showing one of the water purifiers comprising a plurality of the hollow fiber membrane modules of the present invention.

FIG. 18 is a perspective view showing a conventional water purifier.

FIG. 19 is a cross-sectional view showing a conventional water purification cartridge.

### MODES FOR CARRYING OUT THE INVENTION

The water purification cartridge, the water purifier, and the method for cleaning a water purifier of the present invention will be explained in detail. First, the water purification cartridge of the present invention will be explained.

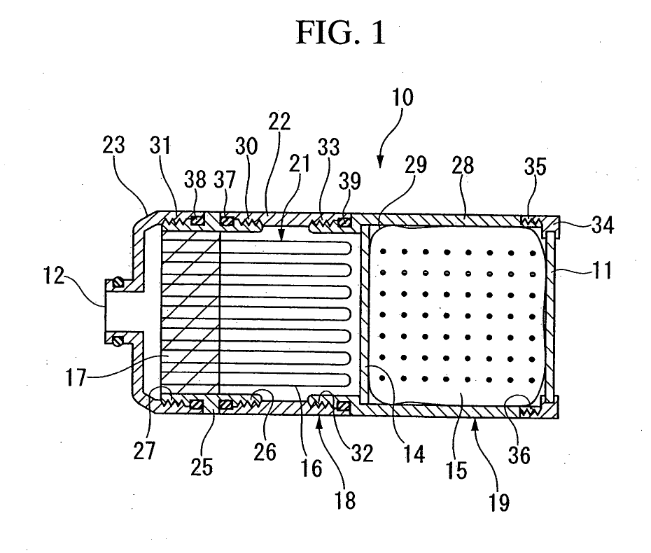

FIG. 1 is a cross-sectional view showing one of the water purification cartridges of the present invention. The water purification cartridge 10 is roughly divided into two parts, one of which is a hollow fiber membrane filter 18 filtering by hollow fiber membranes 16, the other of which is an adsorbent filter 19 filtering by an adsorbent 15. Specifically, the water purification cartridge 10 comprises mainly a hollow fiber membrane element 21 in which both ends of a plurality of the hollow fiber membranes 16 bent in a U-shape are bound by a potting material 17 so as to maintain the open states of the hollow fiber membranes 16, a cylindrical hollow fiber membrane case 22 for covering the hollow fiber membranes 16, a cap 23 covering the front end of the hollow fiber membrane element 21 in which the ends of the hollow fiber membranes 16 are in open states and comprising a purified water outlet 12 at the middle part, and an adsorbent filter 19 which connects the cylindrical hollow fiber membrane case 22.

A cylindrical connection portion 25 is provided to the external side surface of the potting material 17 comprising the hollow fiber membrane element 21. A screw portion 26 is formed on the external side surface and near the rear end of the connection portion 25. Another screw portion 27 is also formed on the external side surface and near the front end of the connection portion 25.

The adsorbent filter 19 comprises an adsorbent case 28, an adsorbent 15 which is installed in the adsorbent case 28 while being filled in a package 29 having a permeability, a connection cover 34 which is provided at the rear end of the adsorbent case 28 and to which a sintered filter 11 is insert-molded, and a partition wall 14 which is provided at the front end of the adsorbent case 28.

The hollow fiber membrane element 21 is fitted detachably to the hollow fiber membrane case 22 so as to maintain a fluid-tight state between the primary side and the secondary side of the hollow fiber membranes by screwing the screw portion 26 of the connection portion 25 to a female screw 30 (connection device) formed in the inside surface near the front end of the hollow fiber membrane case 22. The cap 23 is fitted detachably to the hollow fiber membrane element 21 by screwing a female screw 31 formed in the inside surface of the cap 23 to the screw portion 27 of the connection portion 25 comprising the hollow fiber membrane element 21.

The adsorbent filter 19 is fitted detachably to the hollow fiber membrane case 22 by screwing a screw 32 formed in the outside surface and near the front end of the adsorbent case 28 to a female screw 33 formed in the inside surface and near the rear end of the hollow fiber membrane case 22. The connection cover 34 is fitted detachably to the adsorbent case 28 by screwing a female screw 35 of the ring-shaped connection cover 34 which is provided at the periphery of the sintered filter 11 to a screw 36 formed in the outside surface and near the rear end of the adsorbent case 28.

O-rings 37, 38, and 39 are provided at the connection between the hollow fiber membrane element 21 and the hollow fiber membrane case 22, the cap 23 and the hollow fiber membrane element 21, and the adsorbent filter 19 and the hollow fiber membrane case 22.

The hollow fiber membranes 16 used in the present invention includes, for example, hollow fiber membranes made of celluloses, polyolefines (polyethylene and polypropylene), polyvinyl alcohols, ethylene-vinyl alcohol copolymers, polyethers, methyl polymethacrylates (PMMA), polysulfonates, polyacrylonitriles, polyfluoroethylenes (TEFLON®), polycarbonates, polyesters, polyamides, aromatic polyamides, etc. Among these, taking into account of strength and ductility, flexibility, cleaning ability, usage, and chemical resistance, hollow fiber membranes made of polyolefines such as polyethylene and polypropylene are preferable.

In addition, although the hollow fibers are not limited, hollow fibers having an outside diameter in a range from 20 to 2,000 μm, an inside diameter in a range from 0.01 to 2 μm, and a porosity in a range from 20 to 90%, are preferable. Furthermore, although the hollow fiber membranes are not limited, a membrane thickness in a range from 5 to 300 μm is preferable. In addition, in order to sway and to achieve effective cleaning, an effective hollow fiber membrane length which does not include the length of the potting material 17 is preferably 10 mm or longer, and is more preferably 20 mm or longer. In contrast, if it is too long, efficiency of the hollow fiber membranes decreases; therefore, it is preferably 300 mm or less, and is more preferable to be 200 mm or less.

Examples of the potting material 17 include, for example, fixing resins such as urethane resin, epoxy resin, polyolefin resin, etc.

Examples of the adsorbent 15 include, for example, powder adsorbents, particle adsorbents which are produced by granulating the powder adsorbent, fiber adsorbents, etc. More specifically, examples of the adsorbent 15 include well known adsorbents, for example, inorganic adsorbents such as natural adsorbents (natural zeolite, silver zeolite, acidic clay, etc.), and synthetic adsorbents (synthetic zeolites, antibacterial zeolites, bacteria adsorption polymers, phosphate rock, molecular sieves, silica gels, silica alumina gel based adsorptions, porous glasses, etc.); and organic adsorbents such as powder activated carbons, fiber activated carbons, block activated carbons, extruded activated carbons, molded activated carbons, molecule adsorption resins, synthetic particle activated carbons, synthetic fiber activated carbons, ion exchange resins, ion exchange fibers, chelate resins, chelate fibers, high hydrophilic resins, high hydrophilic fibers, oil adsorbent resins, oil adsorbents, etc. Among these, activated carbons are suitably used, because activated carbons have superior adsorbing ability of chlorine residues, musty odors, and organic compounds such as trihalomethane, which are contaminating water to be treated. These are used alone, in combination, or laminated. Furthermore, as the adsorbent 15, a porous mold adsorbent, which is produced by binding a powder adsorbent, a particle adsorbent, etc., using binders, can be used. The adsorbent 15 is packed in a form such as a powder, particle, fiber, mold, etc., depending on the location of use of the water purifier, use for the purified water, etc.

Examples of the powder activated carbons include, for example, materials which are produced by carbonizing vegetable materials (woods, celluloses, sawdust, charcoals, coconut-shell active carbons, crude ash, etc.), coal materials (peat, lignite, brown lignite, bituminous, anthracite, tar, etc.), petroleum materials (petroleum residues, sulfate sludges, oil carbons, etc.), pulp spent liquors, synthetic resins, etc, and after that, if necessary, they are activated using gas (water vapor, carbon dioxide, air, etc.), or activated using chemicals (calcium chloride, magnesium chloride, zinc chloride, phosphoric acid, sulfuric acid, sodium hydroxide, KOH, etc.). Examples of the fiber activated carbons include, for example, materials which are produced by carbonizing precursors which are produced using polyacrylonitrile (PAN), celluloses, phenols, and coal based pitches as a raw material, and activating them.

As the package 29, any material can be used as long as this can pass water therethrough and does not leak from the adsorbent 15 which is packed in the inside thereof. Examples of the package 29 include, for example, cloths such as pantyhose made of nylon, polyurethane, etc; fabrics such as woven fabric and non-woven fabric; sheets in a mesh; etc.

The sintered filter 11 is a pre-filter for removing objects such as relatively large dusts, sand, iron rust, etc. The sintered filter 11 is a porous powder sintered body, which is produced by sintering and molding in a well known sintering method. For example, the porous powder sintered body can be produced by filling resin powder, metal powder or mixture thereof in a metal mold, heating the metal mold to a temperature higher than the melting temperature of the powder to fuse the contact area of powder, or a porous powder sintered sheet, which is produced by heating resin powder, metal powder or mixture thereof without filling in a metal mold.

Examples of material comprising the sintered filter 11 include, for example, resins comprising olefin resins such as polyethylene and polypropylene, polystyrenes, acrylic resins, fluororesins, etc.; inorganic materials such as C, Si, Mn, P, S, Cr, Mo, Nb, Ta, B, V, Ni, Cu, Al, Ti, Fe, Co, and alloys thereof; and metal materials. Among these, since a sintered filter made of polyolefin resin is light in weight, this can be recycled, and when it burns, it does not release harmful chemicals, and pore size can be easily controlled, polyolefin resins are suitably used.

Instead of the sintered filter 11, non-woven fabrics can be used as a pre-filter.

As the partition wall 14, any material can be used as long as activated carbon fine particles do no leak, and water passes effectively therethrough. Examples of material comprising the partition wall 14 include, for example, resin plates which are produced by insert-molding non-woven fabric or nylon mesh, and attaching or welding them.

Taking into account of workability, plastics are preferable for materials comprising the hollow fiber membrane case 22, the cap 23, and the adsorbent case 28. The inside conditions such as dirtiness of the hollow fiber membranes 16 can be checked by forming these elements of transparent materials or translucent materials.

In addition, heat resistant plastics having a softening point of 80° C. or higher, such as polypropylene, polyphenyl ether, polyoxymethylene, polycarbonate, ABS resin, etc., are more preferable, because hot water having a temperature of 80° C. or higher, which is supplied from a hot-water supply device, can be used directly.

Next, methods for cleaning the water purification cartridge 10 and the water purifier comprising the water purification cartridge 10 will be explained.

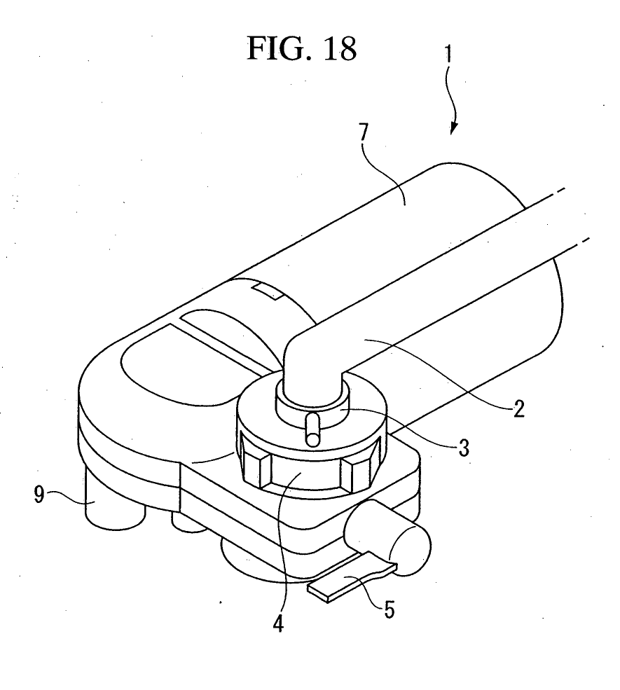

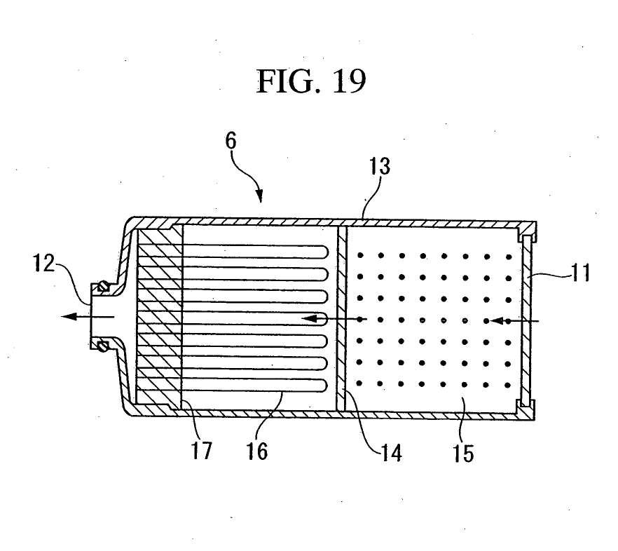

The water purification cartridge 10 can be provided in the water purifier 1, which is already fixed, as shown in FIG. 18, instead of a conventional water purification cartridge 6 shown in FIG. 19.

The water purification cartridge 10 shown in FIG. 1 is installed in the water purifier 1 shown in FIG. 18, the switch lever 5 is turned to a purified water side, raw water is allowed to flow in from the faucet 2, raw water is introduced into the water purification cartridge 10 by the switch mechanism portion, and passes through the inside the water purification cartridge 10, and the raw water becomes purified water, and after that, purified water flows downwardly from the purified water outlet 9.

In the water purification cartridge 10 installed in the water purifier 1, raw water passes through the sintered filter 11 and is introduced into the inside the water purification cartridge 10. Raw water, which is introduced into the inside the water purification cartridge 10, passes through the adsorbent 15, the partition wall 14, and the hollow fiber membranes 16, in that order, and thereby raw water is purified while passing. Purified water obtained by purifying raw water is allowed to flow out from the water purification cartridge 10, via the purified water outlet 12.

When the hollow fiber membranes 16 of the hollow fiber membrane element 21 are blocked, for example, cleaning is carried out as follows.

First, the water purification cartridge 10 is detached from the water purifier. Then, the connection portion 25 of the hollow fiber membrane element 21 and the hollow fiber membrane case 22 are rotated respectively in opposite directions to disassemble them. The exposed hollow fiber membranes 16 are immersed in the clean water, and they are rubbed and washed. At the same time as rubbing and washing, back washing or chemical washing may be conducted.

In chemical washing, chemicals which are effective for cleaning, such as hydrochloric acid, citric acid, acetic acid, household detergent, sodium hypochlorite, bleaching powder, and bleaching agent, can be used.

The hollow fiber membranes 16 can be back washed. That is, dirty can be removed from the secondary side to the primary side of the hollow fiber membranes 16. Specifically, after separating the hollow fiber membrane element 21 and the hollow fiber membrane case 22, a hose is connected the purified water outlet 12, and water is allowed to flow through the hose from the secondary side to the primary side of the hollow fiber membranes 16.

Since the adsorbent filter 19 is connected detachably to the end of the hollow fiber membrane case 22, this can be easily detached.

In the case of a water purification cartridge comprising only the hollow fiber membrane filter 18, from which the adsorbent filter 19 is detached, raw water can be purified by connecting a hose to the purified water outlet 12, and allowing to flow dirty raw water from the hose from the secondary side to the primary side of the hollow fiber membranes 16. Such a water purification cartridge comprising only the hollow fiber membrane filter 18 can be used as a water purifier as it is at where purified water is not readily obtainable such as in an area having no water supply system, and in a disaster area.

As explained above, according to the water purification cartridge 10, since the hollow fiber membrane element 21 is installed detachably to the hollow fiber membrane case 22, when the hollow fiber membranes 16 of the hollow fiber membrane element 21 are blocked, the hollow fiber membrane element 21 and the hollow fiber membrane case 22 are separated to expose the hollow fiber membranes 16, and the exposed hollow fiber membranes 16 can be cleaned.

Since the female screw 30 (connection device) is formed at the inside wall of the hollow fiber membrane case 22, and the connection portion 25 to be screwed to the female screw 30 is formed at the external surface of the potting material 17, detaching between the hollow fiber membrane element 21 and the hollow fiber membrane case 22 is easy.

When function of the adsorbent 15 remarkably decreases, although the hollow fiber membranes 16 have sufficient ability, the adsorbent filter 19, which is connected detachably to the end of the hollow fiber membrane case 22, is detached, and this can be changed to a new one. In this case, the adsorbent 15 is detached by screwing the female screw 35 formed in the connection cover 34.

When the adsorbent 15, which is packed in the permeable package 29, is installed in the adsorbent case 28, a change of the adsorbent 15 in the adsorbent filter 19 can be conducted by merely changing the package 29; therefore, the adsorbent 15 can be easily changed.

The water purification cartridge of the present invention is not limited to the water purification cartridge shown in the figures as long as the hollow fiber membrane element 21, which comprises the hollow fiber membranes 16 and the potting member 17, is installed detachably in the hollow fiber membrane case 22 so that a fluid-tight state is maintained between the primary side and the secondary side of the hollow fiber membranes 16. In addition, in a connection manner, besides in a screwing manner, well known manners such as a bayonet manner, a flange manner, etc., can be adopted. Furthermore, in a sealing manner, besides the O-ring manner, well known manners such as a gasket manner, a V-ring manner, etc., can be adopted.

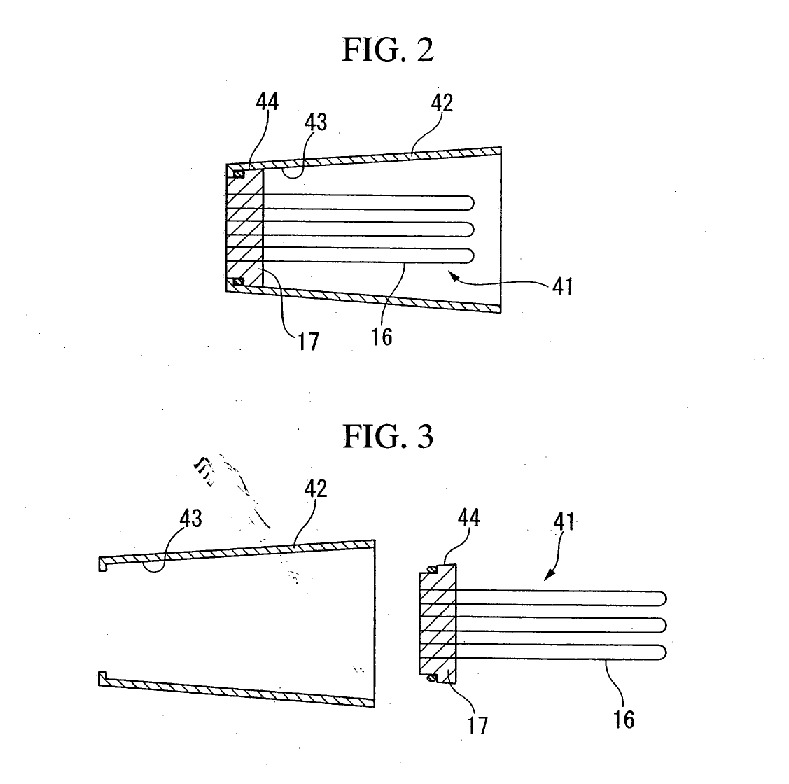

For example, the hollow fiber membrane filter 18 may comprise a hollow fiber membrane case 42 having a tapered inner surface 43, which has the same inclination as that of the tapered side surface 44 of the potting material 17 of the hollow fiber membrane element 41, as shown in FIG. 2. When the side surfaces of the hollow fiber membrane case 44 and the potting material 17 are such tapered surfaces 43 and 44, and raw water is allowed to flow, there is no case in which the hollow fiber membrane element 41 falls out from the front end of the hollow fiber membrane case 42. In addition, the hollow fiber membrane element 41 and the hollow fiber membrane case 41 can be easily separated by pushing the hollow fiber membrane element 41 backward as shown in FIG. 3.

The adsorbent 15 need not always be packed in the package 29, and it may be directly filled in the adsorbent case 28.

In addition, the water purification cartridge of the present invention need not always comprise the adsorbent 15. The water purification cartridge of the present invention may comprise only the hollow fiber membranes 16.

Next, the water purifier of the present invention will be explained.

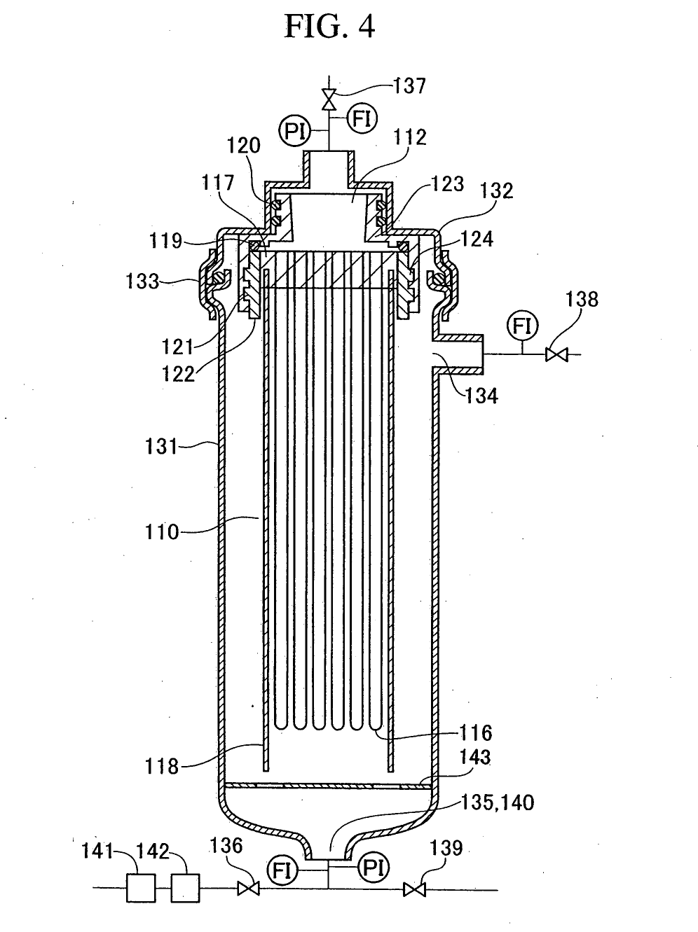

FIG. 4 is a cross-sectional view showing the water purifier of the present invention. In the figure, the symbol FI denotes a flow meter, and PI denotes a pressure meter.

The water purifier comprises mainly a hollow fiber membrane module 110, a cylindrical vessel 131 and a cap 132 in which the hollow fiber membrane module 110 is installed, a hollow fiber membrane case 122 which is arranged between the hollow fiber membrane module 110 and the cylindrical vessel 131, and a module cap 123 which is arranged between the hollow fiber membrane case 122 and the cap 132.

The hollow fiber membrane module 110 is fixed in the cylindrical hollow fiber membrane case 122 such that both ends of a plurality of hollow fiber membranes 116 bent in a U-shape are bound by a potting material 117 so as to maintain the open states of the hollow fiber membranes 116. The hollow fiber module 110 is fixed to the module cap 123 via the hollow fiber membrane case 122 and an elastic member 119. The module cap 123 is fixed to the cap 132 via an elastic member 120. The cap 132 is fixed to the cylindrical vessel 131 via an elastic member 133. In FIG. 4, the hollow fiber membranes 116 which are bonded by the potting material 117, is fixed to the module cap 123 via the hollow fiber membrane case 122 and the elastic member 119. However, the hollow fiber membranes 116 which are bonded by the potting material 117 can be directly fixed to the module cap 123.

When the hollow fiber membrane filling percentage of the hollow fiber membrane module 110, that is, the total percentage of total sectional area of the hollow fiber membranes 116 (based on an outer diameter) with respect to the inner sectional area of the cylindrical vessel 131, is too high, deposits entered between the hollow fiber membranes 116 cannot be readily removed by cleaning. In contrast, if it is too low, since accumulation efficiency decreases, and filtration ability decreases, it is necessary to be in a range from 20 to 60%, preferably in a range from 30 to 50%, and more preferably in a range from 35 to 47.5%.

Taking into account pressure tightness, etc., the material for the cylindrical vessel 131 is preferably metal, and in particular, stainless steel is preferable. Besides metal, plastics can be used. When plastics are used for the cylindrical vessel 131, heat resistant plastics having a softening point of 80° C. or higher, such as polypropylene, polyphenylene ether, polyoxymethylene, polycarbonate, ABS resin, etc., are more preferable, because hot water having a temperature of 80° C. or higher, which is supplied from a hot-water supply device, can be used directly. The inside conditions such as dirtiness of the hollow fiber membranes 116 can be checked by forming the entirety or a part of the cylindrical vessel 131 using transparent materials or translucent materials.

In FIG. 4, the length of the hollow fiber membrane case 122 is shorter than the length of the hollow fiber membranes 116 and the shape of an element comprising the hollow fiber membrane case 122 and the hollow fiber membranes 116 looks like a tea whisk. However, the length of the hollow fiber membrane case 122 may be longer than the length of the hollow fiber membranes 116, or a water passage may be formed in the side of the hollow fiber membrane case 122.

In addition, in FIG. 4, a protection net 118 is provided to improve handling. However, the protection net 118 may not be provided. Furthermore, the protection net 118 is provided detachably to the hollow fiber membrane case 122.

When a pre-filter 141 having a mesh larger than the mesh of the hollow fiber membranes 116 is provided at the upstream of the hollow fiber membrane module 110, since objects such as relatively large dusts, sand, iron rust, etc., in raw water can be removed, the load applied to the hollow fiber membranes 116 can be decreased. As a result, the life service of the hollow fiber membranes 116 is increased. For example, the pre-filter 141 may be a sintered filter made of porous sintered plastic, porous sintered metal, a ceramic, a non-woven fabric, a mesh, etc.

When the pre-filter 141 is provided detachably, since only the pre-filter 141 is detached and cleaned, blockage of the hollow fiber membranes 116 can be effectively prevented.

The pre-filter 141 is, for example, cleaned by physically cleaning such as bywater-washing, rubbing by a brush, burning, and applying ultrasonic waves, or by chemically cleaning such as by immersing in a chemical.

It is preferable for the adsorbent 142 to be provided at the upstream of the hollow fiber membrane module 110, because various water purifications can be conducted.

As the adsorbent 142, adsorbents given as examples may be used. Among these, activated carbons have superior adsorbent ability to remove chlorine residues, musty odors, and organic compounds such as trihalomethane in water to be treated. In order to adjust hardness (Ca, Mg), to remove zinc, nitrite nitrogen, and nitrate nitrogen, ion exchange resins are preferably used. In order to remove arsenic, zeolites are preferably used. In order to remove boric acid and fluorine, chelating agents are preferably used.

As the adsorbent 142, porous molded adsorbent, which is produced by binding powder adsorbents, particle adsorbents, etc., using binders, can be used. In addition, as the adsorbent 142, an adsorbent, in which two or more adsorbents are mixed or laminated, can also be used.

In the water purifier, blocking materials such as bacteria, turbid components, etc., which are deposited on the exterior surface of the hollow fiber membranes 116 are effectively peeled not only during filtration of raw water but also during flow of cleaning solvent by providing the cleaning solvent flow device for making the cleaning solvent flow on at least a part of the exterior surface of the hollow fiber membranes 116 of the hollow fiber membrane module 110 in a circumferential direction with respect to the axis of the cylindrical vessel 131. The cleaning solvent may be any liquid as long as it is clean. The cleaning solvent is preferably raw water, since cleaning is easily conducted.

Here, the flow of the circumferential direction with respect to the axis of the cylindrical vessel 131 means a flow which passes in a circumferential direction when the flow or the stream is observed from the axis of the cylindrical vessel 131, and this is not limited to a flow or a stream which passes in a vertical direction with respect to the axis of the cylindrical vessel 131, and this includes a flow or a stream which passes obliquely with respect to the axis of the cylindrical vessel 131 and a spiral flow or a spiral stream. In addition, the flow or the stream of the circumferential direction with respect to the axis of the cylindrical vessel 131 also includes a flow or a stream containing a partial backflow from the cleaning solvent inlet to the cleaning solvent outlet during passing of the cleaning solvent through the cylindrical vessel 131.

When the cleaning solvent inlet 135 and the cleaning solvent outlet 134 are provided in the cylindrical vessel 131, and the cleaning solvent is supplied in the cleaning solvent inlet 135, after the cleaning solvent is allowed to flow in the circumferential direction of the axis of the cylindrical vessel 131 on the exterior surface of the hollow fiber membranes 116, the cleaning solvent is discharged from the cleaning solvent outlet 134, and blockage materials deposited at the exterior surface of the hollow fiber membranes 116 are removed and discharged from the hollow fiber membrane module 110. The filtration ability of the hollow fiber membranes 116 is thereby recovered.

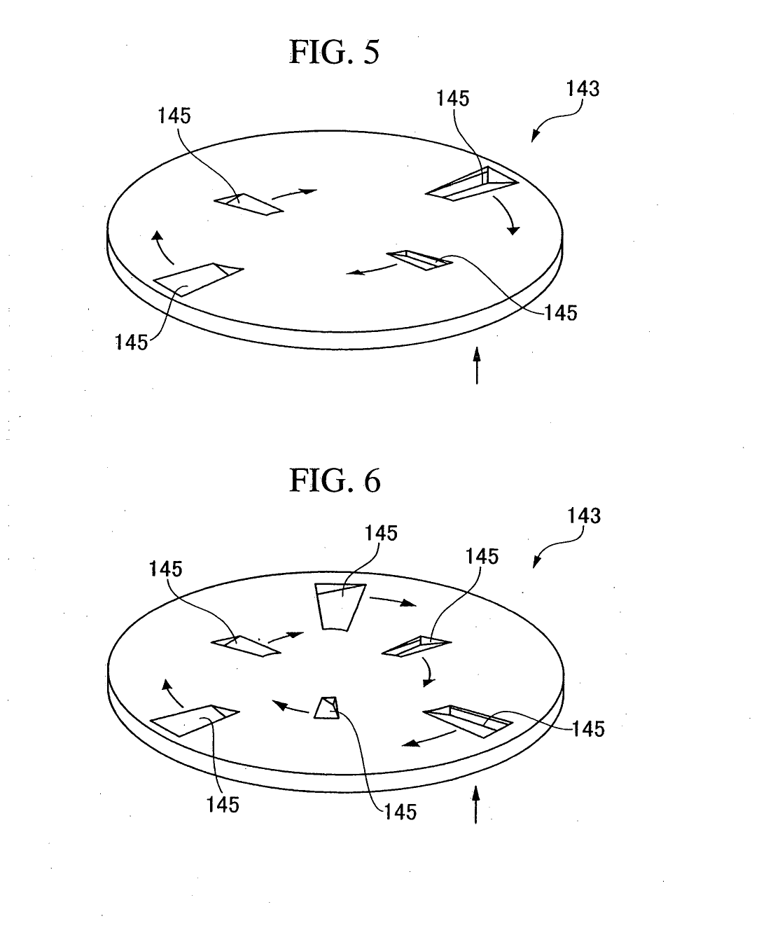

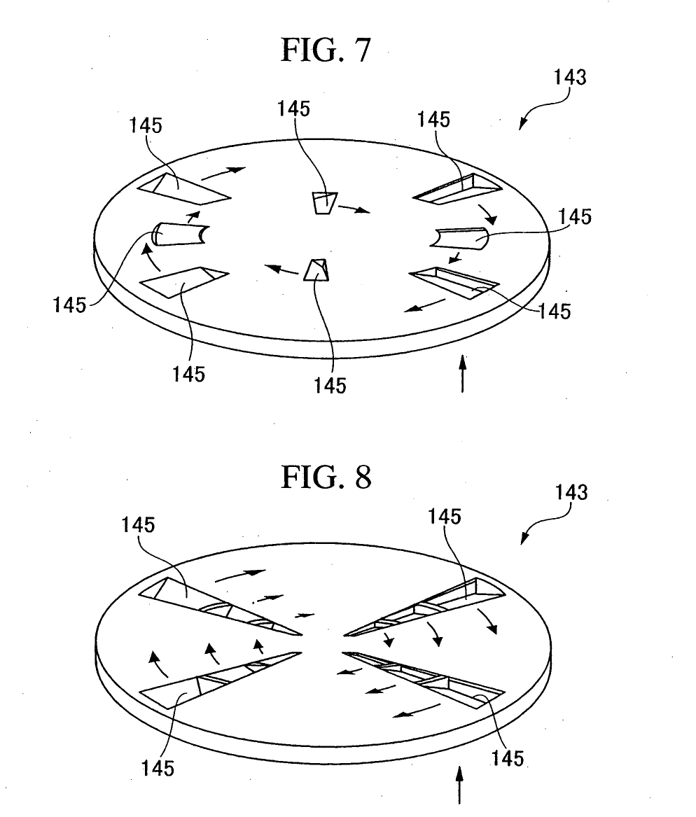

In order to allow the cleaning solvent to flow on the exterior surface of the hollow fiber membranes 116, when the cleaning solvent passage 145, which is formed diagonally with respect to the upper and lower surfaces of the plate member 143, as shown in FIGS. 5 to 8, is formed, the cleaning solvent is allowed to flow in the circumferential direction of the cylindrical vessel 131. In order to disperse the cleaning solvent uniformly through the entirety of the cylindrical vessel 131, as shown in FIGS. 5 to 8, the cleaning solvent passages 145 are preferably arranged uniformly over the entirety of the plate member 143. In FIGS. 5 to 8, the arrow shows the flow direction of water.

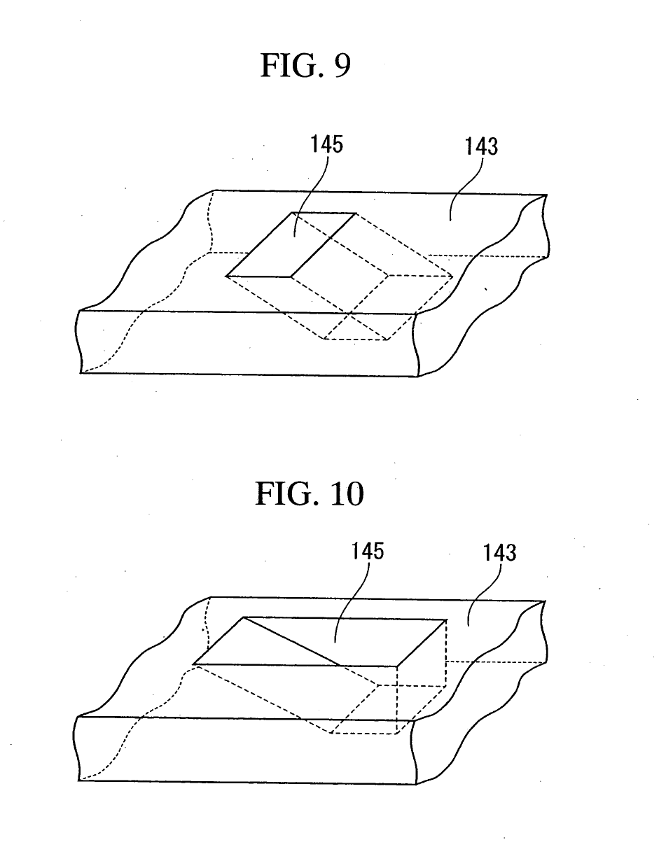

The cleaning solvent passage 145 may be formed obliquely such that the shape thereof is a substantially three-dimensional parallelogram shown in FIG. 9 or a three-dimensional trapezoid as shown in FIG. 10. In addition, the cleaning solvent passage 145 may curve or be diverged in plural passages midway.

The plate member 143 may be arranged at the upstream or around the hollow fiber membrane module 110. In addition, the plate member 143 may also be arranged at the upstream and around of the hollow fiber membrane module 110.

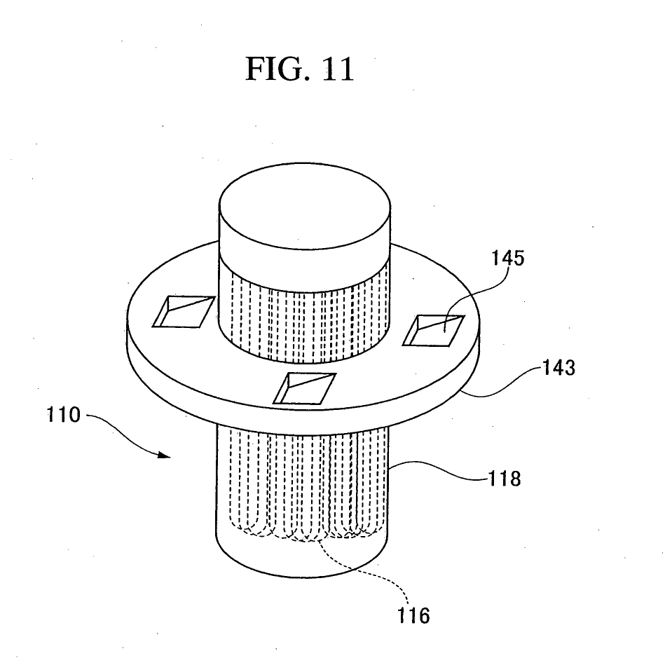

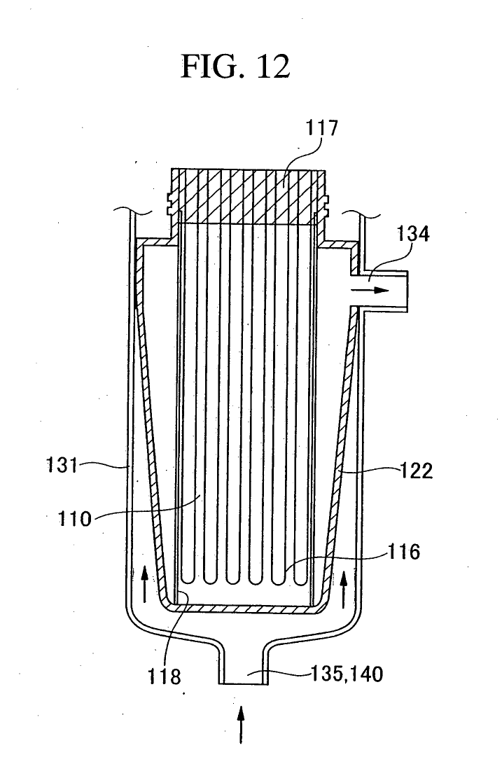

When the plate member 143 is arranged around the hollow fiber membrane module 110, as shown in FIG. 11, it is preferable to provide a hole in the center of the plate member 143 such that the hollow fiber membrane module 110 passes, and to arrange the hollow fiber membrane module 110 in the plate member 143 such that they are arranged concentrically.

The plate member 143 may be arranged at the cylindrical vessel 131 so as to be positioned vertically or obliquely with respect to the axis of the cylindrical vessel 131. The plate member 143 may be of a propeller shape or a spiral shape.

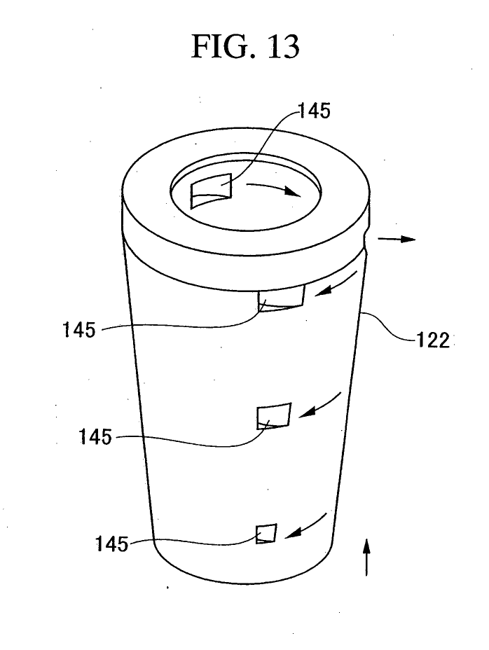

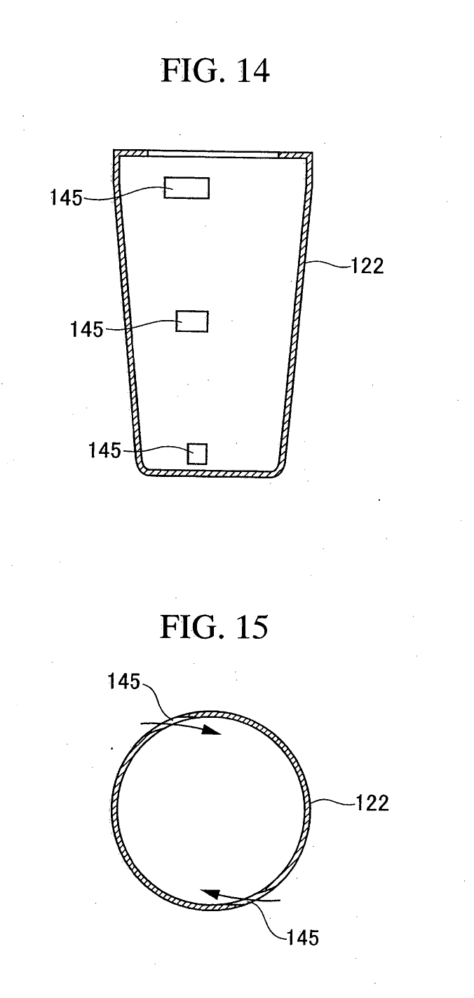

Another cleaning solvent flow device, which is provided outside the hollow fiber membranes 116 and which makes the cleaning solvent flow in the circumferential direction of the cylindrical vessel 131, may be a hollow fiber membrane case 122, which covers the entirety of the hollow fiber membranes 116 of the hollow fiber membrane module 110 and which comprises the cleaning solvent passage 145 formed obliquely in the hollow fiber membrane case 122. In FIGS. 12 to 15, the arrow shows the flow direction of water.

When the cleaning solvent outlet 134 is provided near the fixing part of the hollow fiber membranes 116 on the side surface of the cylindrical vessel 131 as shown in FIG. 4, the cleaning solvent can be allowed to flow through the entirety of the hollow fiber membranes 116. At the same time, since the flow direction of the cleaning solvent changes at the root portion of the hollow fiber membranes 116 at which a blockage occurs most frequently, the root portion of the hollow fiber membranes 116 is effectively cleaned. Therefore, the cleaning solvent outlet 134 is preferably provided near the fixing part of the hollow fiber membranes 116 on the side surface of the cylindrical vessel 131.

Cleaning is possible by providing one cleaning solvent outlet 134; however, two or more cleaning solvent outlets may be provided.

The cleaning solvent inlet 135 may be provided at the side surface of the cylindrical vessel 131, similar to the cleaning solvent outlet 134; however, if the cleaning solvent inlet 135 is also used as the raw water inlet 140, the structure is simplified. Therefore, it is preferable for the cleaning solvent inlet 135 to be used as the raw water inlet 140.

As shown in FIG. 4, when a cleaning solvent switch valve 138 is provided at the cleaning solvent outlet 134, during filtration, raw water is supplied from the raw water inlet 135 while the cleaning solvent switch valve 138 is closed, raw water is filtered by the hollow fiber membranes 116, and then this is discharged from the purified water outlet 112.

In contrast, during cleaning, when the cleaning solvent switch valve 138 is opened and the cleaning solvent is supplied from the cleaning solvent inlet 135, which also functions as the raw water inlet 140, since the cleaning solvent is discharged from the cleaning solvent outlet 134, the exterior surface of the hollow fiber membranes 116 is cleaned. During this, since pressure needed to filter through the hollow fiber membranes 116 is larger than the pressure needed to discharge water from the cleaning solvent outlet 134, almost all of the raw water is discharged from the cleaning solvent outlet 134, and the amount of water filtered is small, it is not always necessary to close the purified water outlet 112.

The amount of the cleaning solvent with respect to an inner standard cross-sectional area of the cylindrical vessel 131, is preferably in a range from 0.01 to 5 liter/cm²·minute, since the surface of hollow fiber membranes are effectively cleaned. This is more preferably in a range from 0.03 to 3.5 liter/cm²·minute, and most preferably in a range from 0.1 to 1.5 liter/cm²·minute.

In contrast to the structure shown in FIG. 4, it is possible to provide the raw water inlet 140 at the side of the cylindrical vessel 131. In this case, cleaning can be conducted by branching the raw water supply line to discharge the cleaning solvent or by providing the cleaning solvent outlet 134 separately from the raw water inlet 140.

In order to clean the hollow fiber membranes 116 which are installed in the water purifier, a chemical having strong detergency can be used, other than raw water. When a chemical is used, cleaning can be conducted effectively by contacting the hollow fiber membranes 116 and chemicals for a fixed time. When a chemical is used for cleaning, the cleaning solvent switch valve 138 provided at the cleaning solvent outlet 134 is closed, the raw water switch valve 136 is also closed, the cleaning solvent inlet switch valve 139 is opened, and then the chemical is supplied from the cleaning solvent inlet 140, which also functions as the raw water inlet 135. After leaving if for a fixed time as it is to contact the chemical and the hollow fiber membranes 116, the chemical is discharged by opening the cleaning solvent outlet switch valve 133. The hollow fiber membranes 116 can thereby be cleaned.

Methods for supplying the chemical are not particularly limited. For example the chemical can be supplied by using a pump, or by positioning the liquid surface of the cleaning solvent tank so as to be higher than the hollow fiber membrane module 110 to use the pressure difference.

The amount of chemical needed to clean is an amount sufficient to fill the inside the cylindrical vessel 131 with the chemical.

The contact time between the chemical and the hollow fiber membranes 116 is adjusted based on kinds and the concentration of chemical used. A time range from 5 to 60 minutes is preferable, because blockage materials at the surface of the hollow fiber membranes 116 can be removed.

The chemical is preferably an aqueous solution containing hydrochloric acid, citric acid, acetic acid, household detergents, sodium hypochlorite, or bleaching materials, because these aqueous solutions have strong cleaning effects, and they are easily and cheaply obtained.

The chemical may be supplied at one time, and also be sequentially supplied during cleaning.

When filtration is conducted immediately after cleaning using the chemical, there is a possibility that the chemical will contaminate the filtered water. Therefore, it is preferable to suitably clean the hollow fiber membrane module 110. In this case, when raw water is supplied from the raw water inlet 135, which also functions as the cleaning solvent inlet 140 and which is provided at the cylindrical vessel 131, and raw water containing the cleaning solvent is discharged from the cleaning solvent outlet 134, since the surface of the hollow fiber membranes 116 is cleaned while cleaning to remove the chemical is conducted, and this improves the cleaning effect. Therefore, this is preferable. Cleaning using raw water may be conducted under the aforementioned conditions.

Since filtration ability is recovered by cleaning the hollow fiber membranes 116, and thereby deposits on the surface of the hollow fiber membranes 116 are washed off, at least one of a filtered amount, a filtration flow rate, and a filtration pressure is measured, and this is used as an index showing recovery of the filtration ability of the hollow fiber membranes 116.

Specifically, a flowmeter such as an impeller flowmeter, a volumetric flowmeter, and electric flowmeter, etc., a current meter, and a pressure meter are provided, and the total filtered amount from cleaning start, filtration flow rate, and filtration pressure are measured, and when these values reach fixed values, cleaning is stopped. In order to control them automatically, electrical meters are preferable.

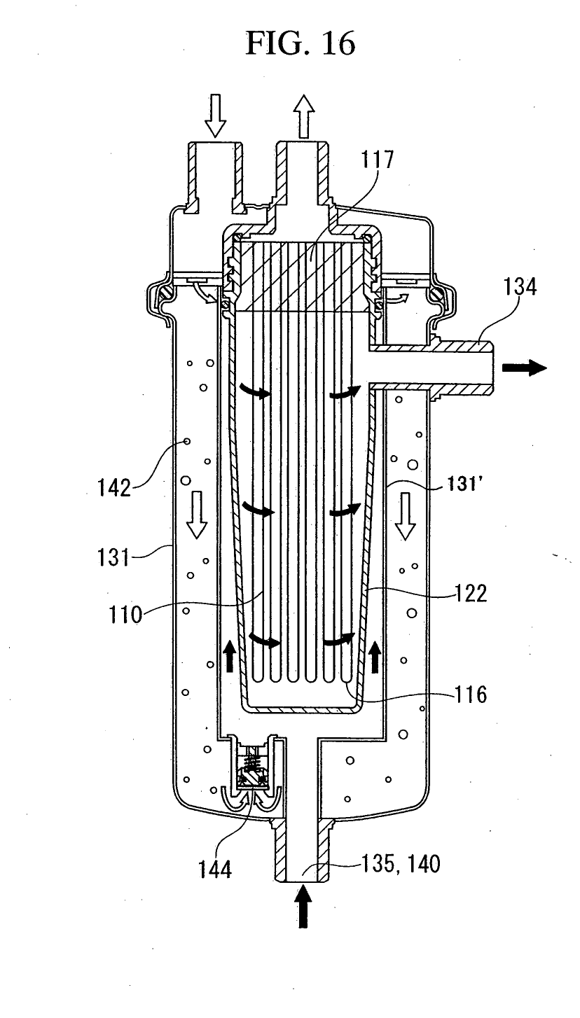

In FIG. 12, the cylindrical vessel 131 does not comprise any adsorbents except the hollow fiber membranes 116. However, the hollow fiber membranes 116 and the adsorbent 142 such as an activated carbon as a filter medium may be installed in the cylindrical vessel 131. For example, as shown in FIG. 16, a structure in which an inner cylindrical vessel 131′ is installed outside the hollow fiber membrane case 122, and an outer cylindrical vessel 131 is further installed outside the inner cylindrical vessel 131′, a check valve 144 is provided to the inner cylindrical vessel 131′, and the adsorbent 142 is filled between the inner and outer cylindrical vessels 131′ and 131, can be adopted. In the water purifier having such a structure, the exterior surface of the hollow fiber membranes 116 can be selectively cleaned without the cleaning solvent flowing to the side of the adsorbent 142. In addition, when the filtration ability of the hollow fiber membranes 116 is sufficient, but the function of the adsorbent 142 remarkably decreases, only the adsorbent 142 need be changed. As this adsorbent 142, the same materials of the adsorbent 14, which is exemplified using FIG. 1, can be used. In FIG. 16, the black arrow denotes a flow direction of water during cleaning, and the white arrow denotes a flow direction of raw water and purified water.

The same cleaning solvent passage 145 that is formed obliquely shown in FIG. 12 etc. may be provided in the hollow fiber membrane case 122.

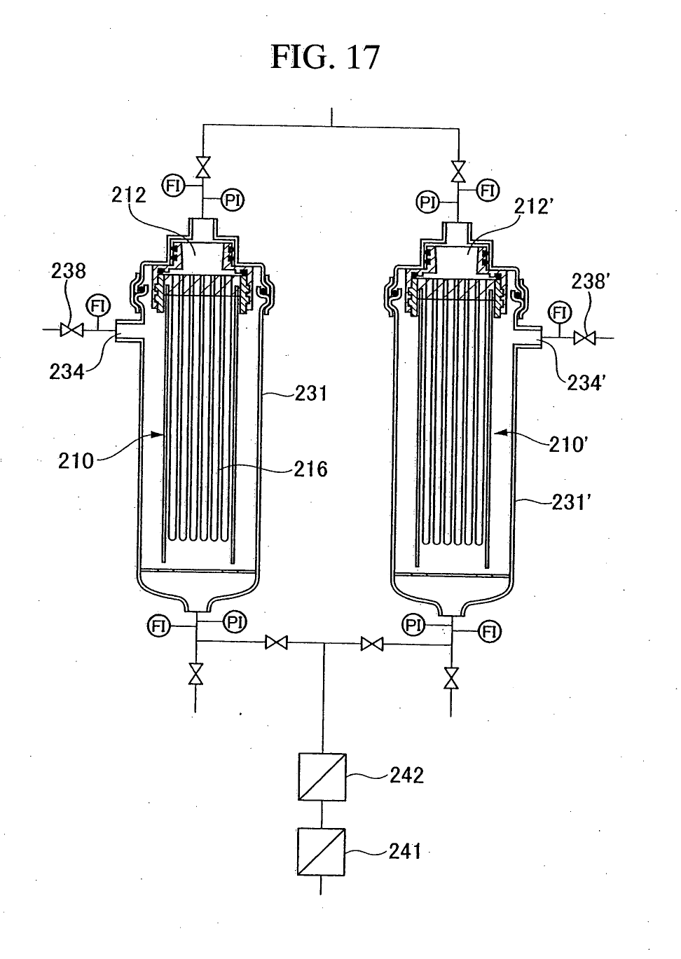

In addition, as shown in FIG. 17, when a plurality of the hollow fiber membrane modules 210 and 210′ are arranged in a line, and while one hollow fiber membrane module 210 is cleaned, the other hollow fiber membrane module 210′ can filter, not only can filtration be conducted while cleaning, but also the filtration life service can be increased compared with a water purifier comprising one hollow fiber module 210 or 210′. Therefore, this is preferable. A filtration can be conducted using either or both of the hollow fiber modules 210 and 210′.

During cleaning, a cleaning switch valve 238, which is provided at the cleaning solvent outlet 234 of the hollow fiber membrane case 231, is closed, and a cleaning switch valve 238′, which is provided at the cleaning solvent outlet 234′ of the other hollow fiber membrane case 231′, is opened. Then, when raw water is supplied in the hollow fiber membrane module 210′ and the cleaning solvent is supplied in the other hollow fiber membrane module 210, filtration is conducted by the hollow fiber membranes 216 in the other hollow fiber membrane module 210, and filtered water is produced from the purified water outlet 212. In the hollow fiber membrane case 231′, the cleaning solvent is discharged from the cleaning solvent outlet 234′, and cleaning of the hollow fiber membranes 216′ can be conducted.

### Industrial Applicability

As explained above, in a water purification cartridge of the present invention, since the hollow fiber membrane element is detachably installed in the hollow fiber membrane case so that a fluid-tight state is maintained between the primary side and the secondary side of the hollow fiber membranes, when the hollow fiber membranes of the hollow fiber membrane element are blocked, the hollow fiber membrane element and the hollow fiber membrane case are separated to expose the hollow fiber membranes, and the exposed hollow fiber membranes can be cleaned. The hollow fiber membranes can thereby be regenerated, and it is possible to use the water purification cartridge for a long time. Due to this, operating cost for purification treatment can be reduced.

The present invention also provides a water purifier in which the water purification cartridge is installed.

The present invention also provides another water purifier comprising the hollow fiber membrane module in which the ends of the hollow fiber membranes are fixed to one end of a cylindrical vessel while the ends of the hollow fiber membranes are maintained in open states, wherein the hollow fiber membrane module has a hollow fiber membrane filling percentage in a range from 20 to 60%, and wherein the cylindrical vessel comprises a cleaning solvent inlet and a cleaning solvent outlet for cleaning the exterior surface of the hollow fiber membranes.

The present invention also provides another water purifier comprising the cleaning solvent flow device for making a cleaning solvent flow on at least a part of the exterior surface of the hollow fiber membranes in a circumferential direction with respect to the axis of the cylindrical vessel.

According to the water purifier, operating cost for purification treatment can be reduced.

The present invention provides a method for cleaning a water purifier which comprises a hollow fiber membrane module in which the ends of the hollow fiber membranes are fixed to one end of a cylindrical vessel while the ends of the hollow fiber membranes are maintained in open states, the hollow fiber membrane module has a hollow fiber membrane filling percentage in a range from 20 to 60%, and the cylindrical vessel comprises a cleaning solvent inlet and a cleaning solvent outlet for cleaning the exterior surface of the hollow fiber membranes, the method comprises the steps of: supplying raw water from the cleaning solvent inlet, and after the raw water passes through the hollow fiber membranes, discharging the raw water from the cleaning solvent outlet.

In addition, the present invention also provides another method for cleaning a water purifier which comprises a hollow fiber membrane module in which the ends of the hollow fiber membranes are fixed to one end of a cylindrical vessel while the ends of the hollow fiber membranes are maintained in open states, the hollow fiber membrane module has a hollow fiber membrane filling percentage in a range from 20 to 60%, and the cylindrical vessel comprises a cleaning solvent inlet and a cleaning solvent outlet for cleaning the exterior surface of the hollow fiber membranes, the method comprises the steps of: supplying cleaning solvent from the cleaning solvent inlet; maintaining the conditions for a fixed time; and discharging the cleaning solvent from the cleaning solvent outlet.

According to the method for cleaning, the blocked hollow fiber membranes can be restored, and it is possible to use the water purification cartridge for a long time. Due to this, operating cost for purification treatment can be reduced.

1. A water purification cartridge comprising:
a hollow fiber membrane element comprising a plurality of hollow fiber membranes bent in a U-shape and a potting material for binding both ends of the hollow fiber membranes so as to maintain the open states of the hollow fiber membranes; and
a cylindrical hollow fiber membrane case for covering the hollow fiber membranes,
wherein the hollow fiber membrane element is detachably installed in the hollow fiber membrane case so that a fluid-tight state is maintained between the primary side and the secondary side of the hollow fiber membranes.

2. A water purification cartridge according to claim 1, wherein a connection device is provided at the hollow fiber membrane case, and one connection member which is one of a screw type connection member, a bayonet type connection member, and a flange type connection member, and which engages the connection device, is provided at the side surface of the potting material.

3. A water purification cartridge according to claim 2, wherein an adsorbent filter, which comprises an adsorbent case and an adsorbent installed in the adsorbent case, is detachably connected to one end of the hollow fiber membrane case, and a detachable cover is provided to the adsorbent case such that the adsorbent installed in the adsorbent case is freely changed.

4. A water purification cartridge according to claim 3, wherein the adsorbent is installed in the adsorbent case while the adsorbent is filled in a package through which water passes.

5. A water purifier comprising the water purification cartridge according to claim 1.

6. A water purifier comprising:
a hollow fiber membrane module in which the ends of the hollow fiber membranes are fixed to one end of a cylindrical vessel while the ends of the hollow fiber membranes are maintained in open states,
wherein the hollow fiber membrane module has a hollow fiber membrane filling percentage in a range from 20 to 60%, and wherein the cylindrical vessel comprises a cleaning solvent inlet and a cleaning solvent outlet for cleaning the exterior surface of the hollow fiber membranes.

7. A water purifier according to claim 6, wherein the cleaning solvent inlet is a raw water inlet.

8. A water purifier according to claim 6, wherein the cleaning solvent inlet is provided in the side surface of the cylindrical vessel at a location near the portion at which hollow fiber membranes are fixed.

9. A water purifier according to claim 6, wherein an adsorbent is installed at the upstream with respect to the hollow fiber membrane module.

10. A water purifier according to claim 6, wherein the water purifier comprises a cleaning solvent flow device for making a cleaning solvent flow on at least a part of the exterior surface of the hollow fiber membranes in a circumferential direction with respect to the axis of the cylindrical vessel.

11. A water purifier according to claim 10, wherein the cleaning solvent flow device is a plate member comprising at least one cleaning solvent passage which is diagonally disposed across the plate member.

12. A water purifier according to claim 11, wherein the plate member is provided at at least one position of the upstream and the circumference of the hollow fiber membranes.

13. A water purifier according to claim 6, wherein a pre-filter having a mesh larger than the mesh of the hollow fiber membranes is provided at the upstream of the hollow fiber membrane module.

14. A water purifier according to claim 13, wherein the pre-filter is installed detachably.

15. A water purifier according to claim 6, wherein a plurality of the hollow fiber membrane modules are arranged in a line, and while one of the hollow fiber membrane modules is being cleaned, another hollow fiber membrane module filters.

16. A water purifier according to claim 6, wherein the water purifier comprises at least one measuring device for measuring total filtration time, total filtered amount, a filtration flow rate, and a filtration pressure.

17. A water purifier comprising a cleaning solvent flow device for making a cleaning solvent flow on at least a part of the exterior surface of hollow fiber membranes of a hollow fiber membrane module installed in a cylindrical vessel, in a circumferential direction with respect to the axis of the cylindrical vessel.

18. A method for cleaning a water purifier which comprises a hollow fiber membrane module in which the ends of hollow fiber membranes are fixed to one end of a cylindrical vessel while the ends of the hollow fiber membranes are maintained in open states, the hollow fiber membrane module has a hollow fiber membrane filling percentage in a range from 20 to 60%, and the cylindrical vessel comprises a cleaning solvent inlet and a cleaning solvent outlet for cleaning the exterior surface of the hollow fiber membranes, the method comprising the steps of: supplying raw water from the cleaning solvent inlet, and after the raw water passes through the hollow fiber membranes, discharging the raw water from the cleaning solvent outlet.

19. A method for cleaning a water purifier according to claim 18, wherein the cleaning solvent is allowed to flow on the exterior surface of at least a part of the hollow fiber membranes in the circumferential direction with respect to the axis of the cylindrical vessel.

20. A method for cleaning a water purifier according to claim 19, wherein the cleaning solvent is allowed to flow in the circumferential direction of the cylinder vessel by passing through cleaning solvent passages which are diagonally disposed across the plate member.

21. A method for cleaning a water purifier which comprises a hollow fiber membrane module in which the ends of hollow fiber membranes are fixed to one end of a cylindrical vessel while the ends of the hollow fiber membranes are maintained in open states, the hollow fiber membrane module has a hollow fiber membrane filling percentage in a range from 20 to 60%, and the cylindrical vessel comprises a cleaning solvent inlet and a cleaning solvent outlet for cleaning the exterior surface of the hollow fiber membranes, the method comprising the steps of: supplying chemical from the cleaning solvent inlet; maintaining the conditions for a fixed time; and discharging the chemical from the cleaning solvent outlet.

22. A method for cleaning a water purifier according to claim 21, wherein the chemical is an aqueous solution containing one of hydrochloric acid, citric acid, acetic acid, household detergents, and hypochlorites.

23. A method for cleaning a water purifier according to claim 21, wherein after discharging the chemical from the cleaning solvent outlet, raw water is further supplied from the cleaning solvent inlet and is then allowed to flow through the hollow fiber membranes, and the raw water is then discharged from the cleaning solvent outlet.

24. A method for cleaning a water purifier according to one of claims 18 and 21, wherein a pre-filter having a mesh larger than the mesh of the hollow fiber membranes is provided at the upstream of the hollow fiber membrane module.

25. A method for cleaning a water purifier according to claim 24, wherein the pre-filter is installed detachably and is detached to be cleaned.

26. A method for cleaning a water purifier according to one of claims 18 and 21, wherein at least one of total filtration time, total filtered amount, filtration flow rate, and filtration pressure is measured, and an automatic cleaning is conducted when the at least one reaches to a predetermined fixed value.

27. A method for cleaning a water purifier according to one of claims 18 and 21, wherein the cleaning solvent is supplied from the cleaning solvent inlet, the cleaning solvent is allowed to flow through the hollow fiber membranes, and the cleaning solvent is discharged from the cleaning solvent outlet, and thereby cleaning of the hollow fiber membranes is conducted, while filtration is also conducted, and total filtered amount or filtration flow rate is measured from the beginning of the cleaning, the cleaning is terminated when the total filtered amount or the filtration flow rate reaches a predetermined fixed value.
